(19) United States
(12) Patent Application Publication
(10) Pub. No.: US 2017/0072520 A1
(43) Pub. Date: Mar. 16, 2017

(54) SCREW SYSTEM

(71) Applicant: WEBER SCHRAUBAUTOMATEN GmbH, Wolfratshausen (DE)

(72) Inventor: Franz Kroll, Geretsried (DE)

(73) Assignee: WEBER SCHRAUBAUTOMATEN GMBH, Wolfrastshausen (DE)

(21) Appl. No.: 15/309,071

(22) PCT Filed: Apr. 30, 2015
(86) PCT No.: PCT/EP2015/059569

§ 371 Date: Nov. 4, 2016

(30) Foreign Application Priority Data
May 8, 2014 (DE) 10 2014 106 476.3

(51) Int. Cl. B23P 19/00; F15B 11/032; F15B 11/072; B23P 19/06

(52) U.S. Cl. CPC B23P 19/006; B23P 19/065; F15B 11/0325; F15B 11/0725; F15B 2211/76

(57) ABSTRACT

The invention relates to a screw system for carrying out screwing operations, in particular automatically, with a screwing tool and a feed device having a pneumatic feed cylinder by means of which the screwing tool is movable in a feed direction in order to be brought into engagement with a screw and to drive the latter into components to be screwed together with a first feed force during a screwing operation.

The invention relates to a screwing system for the carrying out, in particular for the automatic carrying out, of screwing procedures, comprising a screwing tool and a feed device having a pneumatic feed cylinder by means of which the screwing tool is movable in a feed direction to be brought into engagement with a screw and to drive it into components to be screwed with a first feed force during a screwing procedure.

In a known screwing system of this kind, the pneumatic feed cylinder serves both for the delivery of the screwing tool to the screw and to the screwing location and for the driving forward of the screw during the screwing procedure. Such a screwing system proves to be problematic in the carrying out of flow-drilling screwing procedures since the screw has to be pressed onto the components with a high force, which cannot be provided by the pneumatic feed cylinder alone, for the heating of the screwing position of the components to be connected to one another. A sufficiently high pressure could only be provided with the known screwing system by a larger pneumatic feed cylinder which would, however, be undesirable due to its larger construction shape, the air volumes associated therewith and the accompanying larger system inertia.

It is the underlying object of the invention to further develop a screwing system of the initially named kind such that it is also suitable for the carrying out of flow-drilling screwing procedures while maintaining a construction size which is as compact as possible.

The object is satisfied by a screwing system having the features of claim 1 and in particular in that the feed device comprises a pressure intensifier by which a second feed force which is larger than the first feed force can be exerted onto the screwing tool during the screwing procedure.

In accordance with the invention, a splitting of the feed movement of the screwing tool therefore takes place into a delivery stroke with a smaller force (first feed force) and a force stroke with a higher force (second feed force), wherein the delivery stroke is only effected by the pneumatic feed cylinder and a force assistance by the pressure intensifier takes place during the force stroke. The pneumatic feed cylinder also does not have to have larger dimensions for flow-drilling applications thanks to this splitting of the feed movement since the pressing force of the screw required for the heating of the components in flow-drilling screwing is effected by the pressure intensifier. A comparatively small air volume can therefore also be maintained for the actuation of the pneumatic feed cylinder during flow-drilling screwing, which has a positive effect on the economy of the screwing system. Better dynamics of the screwing system are simultaneously achieved by the fast response behavior of the pressure intensifier.

Advantageous embodiments of the invention can be seen from the dependent claims, from the description and from the drawing.

In accordance with an embodiment, the pressure intensifier can be switched on and off at any desired time of the feed movement of the screwing tool. The pressure intensifier can additionally preferably be metered, in particular by a control pressure which can e.g. be controlled by means of a proportional valve. The force stroke can consequently be metered such as is required for a desired process routine. The screwing system can hereby be adapted particularly flexibly to different applications, in particular to different screws and to components to be screwed. The pressure intensifier does not, for example, have to be active during the total screwing procedure. It is thus sufficient for a number of flow-drilling screwing applications only to exert an elevated feed force onto the screw for so long until the components to be screwed have been heated so much that the screw can penetrate into them in a flow-drilling manner. The pressure intensifier therefore only has to be switched on during an initial phase of the screwing procedure in such a case, whereas the feed force exerted by the feed cylinder can be sufficient for the drive of the screw during the remaining phase of the screwing procedure. In general, the pressure intensifier can, however, also be activated during other phases of the screwing procedure, optionally with different forces, or during the total screwing procedure with an optionally varying force.

In accordance with a further embodiment, the feed cylinder has a pneumatically actuable working piston which can carry out a maximum working stroke. The maximum working stroke is limited by the length of the feed cylinder and is ideally selected such that it is not completely extended even on a screwing of longer screws.

Since the pressure intensifier can be switched on at any desired time of the feed movement of the screwing tool, i.e. it can be switched on at any desired stroke position of the working piston, it is sufficient for the reliable carrying out of a screwing procedure and it is advantageous for the construction size of the screwing system if the pressure intensifier effects a force stroke of the working piston which is smaller than the maximum working stroke.

In accordance with a further embodiment, the pressure intensifier comprises an actuation piston. The actuation piston can be coaxially aligned with the working piston of the feed cylinder. It is, however, particularly advantageous if the actuation piston is arranged offset from the working piston since this allows a more compact construction size of the screwing system. For example, the actuation piston can be arranged offset in parallel with the working piston and/or can act in a different direction, e.g. an opposite direction or a non-parallel direction.

It is generally conceivable to effect a force transmission from the actuation piston onto the working piston by means of a gaseous fluid. The force transmission from the actuation piston onto the working piston preferably takes place, however, by means of a hydraulic fluid since it shows a faster response behavior on the switching on and off of the pressure intensifier and additionally allows the transmission of higher forces. The hydraulic fluid is advantageously located in a hydraulic system which is closed in itself or encapsulated, which contributes to an increased economy of the screwing system and which simplifies use in a dry environment.

In accordance with a further embodiment, the actuation piston can be pneumatically actuated, which is advantageous in that compressed air is anyway available for the actuation of the feed cylinder.

If the actuation of the actuation piston takes place pneumatically and if the force transmission from the actuation piston onto the working piston takes place hydraulically, the pressure intensifier is a pneumohydraulic pressure intensifier. As already mentioned, it is, however, also conceivable to actuate the actuation piston pneumatically and also to transmit the force from the actuation piston onto the working piston pneumatically, in which case the pressure intensifier would be a pneumatic pressure intensifier. It is conversely possible to implement both the actuation of the actuation piston and the force transmission from the actuation piston onto the working piston hydraulically, in which case it would be a hydraulic pressure intensifier.

In accordance with a further embodiment, the feed device moves the screwing tool together with a torque measuring device. Alternatively, the feed device could, however, also move the screwing tool together with a drive unit for the screwing tool and optionally together with a torque measuring device or even only the screwing tool, i.e. without the torque measuring device and the drive unit.

In accordance with yet a further embodiment, the screwing system comprises a supply head for holding the screw in a position aligned for the engagement of the screwing tool. The supply head contributes to the delivered screwing tool being able to engage correctly at the screw and to the screw in particular not being able to tilt during an initial phase of the screwing procedure.

To enable an automatic carrying out of screwing procedures, the screwing system preferably furthermore comprises a supply device for the automatic supply of screws into the supply head.

The invention will be described in the following purely by way of example with reference to a possible embodiment and to the enclosed drawing. There is shown:

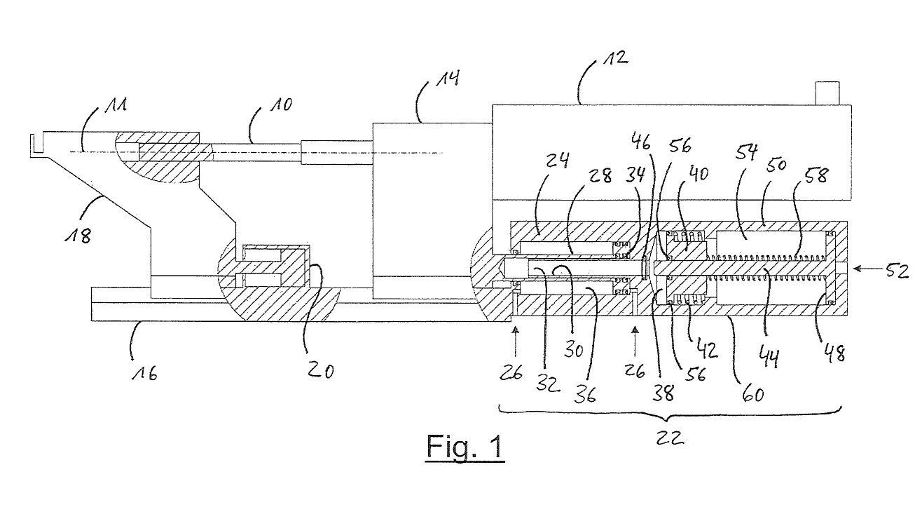

FIG. 1 a schematic, partly sectional side view of a screwing system in accordance with the invention.

A screwing system in accordance with the invention is shown schematically in FIG. 1 which can, for example, be installed at a robot arm or statically at a rack to carry out flow-drilling screwing procedures automatically.

The screwing system comprises a screwing tool 10 which defines a central longitudinal axis 11 and is rotationally drivable about the central longitudinal axis 11 by means of a rotary drive 12. A torque measuring device 14 is connected between the screwing tool 10 and the rotary drive 12.

The screwing system furthermore comprises a guide 16 which extends in parallel with the central longitudinal axis 11 of the screwing tool 10 and on which a supply head 18 is displaceably supported which can be traveled along the guide 16 by means of a delivery cylinder 20 to be brought into contact with a component to be screwed. The supply head 18 serves for the alignment and holding of a screw provided for the screwing procedure and not shown in the Figure. To supply the screw into the supply head 18, the latter is coupled to an automatic supply device, likewise not shown, which, for example, shoots the screw into the supply head 18 by means of compressed air.

To bring the screwing tool 10 into engagement with the screw held in the supply head 18, the screwing tool 10 is pushed forward, together with the torque measuring device 14, out of the rear end position shown in FIG. 1, which can also be called a position of rest, to the front, that is to the left in FIG. 1. A feed device 22 serves this purpose which acts on the torque measuring device 14 which is in turn displaceably supported on the guide 16.

The feed device 22 comprises a pneumatic feed cylinder 24 having a working piston 28 which is oriented in parallel with the screwing tool 10 and with the guide 16, which can be actuated by means of compressed air 26 and which can carry out a maximum working stroke predefined by the length of the feed cylinder 24. The working piston 28 is coupled to the torque measuring device 14 and can e.g. be molded onto a housing of the torque measuring device 14.

The working piston 28 is furthermore configured as hollow cylindrical and is displaceably supported on a pipe piece 30 which extends from the rear, that is from the right in FIG. 1, into the working piston 28. The inner space 37 bounded by the pipe piece 30 and by the working piston 28 is filled with a hydraulic fluid and is sealed with respect to an air space 36 of the feed cylinder 24 by means of seals 34.

The inner space 32 has a first cross-sectional surface and opens at its rear end into a fluid storage space 38 which is likewise filled with hydraulic fluid and has a second cross-sectional surface which is larger by a multiple than the cross-sectional surface of the inner space 32. The fluid storage space 38 is bounded at the rear side by a displaceably supported ring piston 40 which is urged to the front, i.e. in the direction of the feed cylinder 24, by an equalizing spring 42. The inner space 32 and the fluid storage space 38 together form a hydraulic system closed in itself.

A plunger 44 which is coaxially aligned with the pipe piece 30 extends through the ring piston 40 and its profile is adapted to the profile of the pipe piece 30 such that it can dip sealingly into the pipe piece 30, with the sealing effect being additionally improved by a seal 46 arranged in the end region of the pipe piece 30.

The plunger 44 is part of an actuation piston 48 which is displaceably supported in a force cylinder 50 and which can be actuated by means of compressed air 52. The sealing of an air space 54 of the force cylinder 50 with respect to the fluid storage space 38 takes place by means of seals 56 which are let into the ring piston 40.

The plunger 44 is surrounded by a return spring 58, here in the form of a helical compression spring, which is supported at a rear side of the ring piston 40, on the one hand, and at a front side of the actuation piston 48, on the other hand, and which urges the ring piston 40 and the actuation piston 48 apart. Alternatively, the return spring 58 can be configured in the form of a pneumatic spring.

The components 30 to 58 together form a pneumohydraulic pressure intensifier 60 of the feed device 22 whose function will be explained in the following.

To bring the screwing tool 10 out of its position of rest shown in FIG. 1 into engagement with a screw held in the supply head 18, the feed cylinder 24 has compressed air 26 applied such that the working piston 28 is moved to the left in FIG. 1 and in so doing pushes the torque measuring device 14 and the screwing tool 10 to the front. When the screwing tool 10 is in engagement with the screw, the screwing tool 10 is pushed further forward by the feed cylinder 24 actuated by compressed air until the screw adjoins the component to be screwed.

The inner space 32 increases due to the movement of the working piston 28 to the front, with hydraulic fluid being urged on into the inner space 32 from the fluid storage space 38 by the ring piston 40 acted on by the equalizing spring 42.

Since the force which can be applied onto the feed cylinder 24 by the compressed air 26 is not sufficient to introduce a heat sufficient for the flow-drilling screwing procedure into the component to be screwed within a time acceptable for an economic screwing procedure, the pressure intensifier 60 is activated as soon as the screw adjoins the component to be screwed.

This is done in that compressed air 52 is applied to the actuation piston 48 and the plunger 44 is thereby pushed to the front. As soon as the plunger 44 dips into the pipe piece 30, the inner space 23 is sealed with respect to the fluid storage space 38 and hydraulic fluid can no longer escape from the inner space 32 or flow on into it. A further application of compressed air 52 to the actuation piston 48 now has the effect that a second feed force is exerted onto the screwing tool 10 via the working piston 28, said second feed force being substantially larger than the first feed force which can be exerted onto the working piston 28 by the compressed air 26. Under the assumption that the compressed air 52 acting on the actuation piston 48 is at the same pressure as the compressed air 26 acting on the working piston 28, the ratio of the second feed force to the first feed force approximately corresponds to the ratio of the cross-sectional surface of the actuation piston 48 to the cross-sectional surface of the plunger 44.

The pressure of the compressed air 52 can be controlled, e.g. by a pneumatic proportional valve controlled by a control, to meter the second feed force.

It is understood that the pressure intensifier 60 is dimensioned such that the second feed force is sufficiently large to heat the component to be screwed within a time acceptable for the process procedure to a temperature sufficiently high for the flow-drilling screwing.

As soon as the component has reached a sufficient flow capability, the screw is driven into the component with a further feed of the screwing tool 10. After reaching a sufficient flow capability of the component, it is generally possible to deactivate the pressure intensifier 60 again in that the supply of the compressed air 52 is stopped and the plunger 44 is drawn out of the pipe piece 30 again by the return spring 58 such that the hydraulic fluid can again flow on out of the fluid storage space 38 into the inner space 32, while the feed of the screwing tool 10 during the remaining phase of the screw procedure is implemented by applying compressed air 26 to the working piston 28. It is, however, generally also conceivable to carry out the whole screwing procedure with the pressure intensifier switched on provided that it can carry out a sufficiently high stroke, with the second feed force also being able to be metered here by the use of a pressure-regulated control pressure of the pressure intensifier 60.

It must finally be pointed out that the arrangement of the pressure intensifier 60 relative to the feed cylinder 24 shown in FIG. 1 is only of a schematic nature. The pressure intensifier 60 thus does not necessarily have to be coaxially aligned with the feed cylinder 24. For a more compact construction size of the screwing system, the pressure intensifier 60 can, for example, also be arranged offset in parallel with the feed cylinder 24 and can even act in the opposite direction. In the latter case, the pipe piece 30 could form the one limb of a U-shaped hydraulic passage, while the plunger 44 dips in the other limb of the U-shaped hydraulic passage on activation of the pressure intensifier 60.

### REFERENCE NUMERAL LIST

10 screwing tool

11 central longitudinal axis

12 rotary drive

14 torque measuring device

16 guide

18 supply head

20 delivery cylinder

22 feed device

24 feed cylinder

26 compressed air

28 working piston

30 pipe piece

32 inner space

34 seal

36 air space

38 fluid storage space

40 ring piston

42 equalizing spring

44 plunger

46 seal

48 actuation piston

50 force cylinder

52 compressed air

54 air space

56 seal

58 return spring

60 pressure intensifier

1-11. (canceled)

12. A screwing system for carrying out screwing procedures, the screwing system comprising a screwing tool and a feed device having a pneumatic feed cylinder by means of which the screwing tool is movable in a feed direction to be brought into engagement with a screw and to drive the screw into components to be screwed with a first feed force during a screwing procedure,
wherein the feed device comprises a pressure intensifier by which a second feed force, which is larger than the first feed force, can be exerted onto the screwing tool during the screwing procedure.

13. The screwing system in accordance with claim 12,
wherein the screwing system is configured for an automatic carrying out of screwing procedures.

14. The screwing system in accordance with claim 12,
wherein the pressure intensifier can be switched on and off at any desired time of the feed movement of the screwing tool.

15. The screwing system in accordance with claim 12,
wherein the pressure intensifier can be metered.

16. The screwing system in accordance with claim 15,
wherein the feed cylinder has a pneumatically actuable working piston, with the pneumatically actuable working piston being configured to carry out a maximum working stroke and the pressure intensifier being configured to effect a force stroke of the working piston which is smaller than the maximum working stroke.

17. The screwing system in accordance with claim 15,
wherein an actuation piston of the pressure intensifier is arranged coaxially with or offset from the pneumatically actuable working piston.

18. The screwing system in accordance with claim 15,
wherein a force transmission from an actuation piston of the pressure intensifier onto the pneumatically actuable working piston takes place by means of a hydraulic fluid.

19. The screwing system in accordance with claim 12,
wherein an actuation piston of the pressure intensifier is configured to be pneumatically actuated.

20. The screwing system in accordance with claim 19,
wherein the actuation piston of the pressure intensifier is configured to be metered by the pneumatic actuation pressure.

21. The screwing system in accordance with claim 12,
wherein the pressure intensifier is a pneumatic, a hydraulic or a pneumohydraulic pressure intensifier.

22. The screwing system in accordance with claim 12,
wherein the feed device only moves the screwing tool or moves the screwing tool together with a torque measuring device and/or with a drive unit.

23. The screwing system in accordance with claim 12,
further comprising a feed head for holding the screw in a position aligned for the engagement of the screwing tool.

24. The screwing system in accordance with claim 23,
further comprising a feed device for the automatic supply of screws into the feed head.

25. The screwing system in accordance with claim 12,
further comprising a feed device for the automatic supply of screws into a feed head.
